(19) United States
(12) Patent Application Publication
(10) Pub. No.: US 2023/0365204 A1
(43) Pub. Date: Nov. 16, 2023

(54) SPARE TIRE MOUNT WITH AN INTEGRATED AIR TANK ASSEMBLY

(71) Applicant: Joshua Baltimore, Santa Rosa Valley, CA (US)

(72) Inventor: Joshua Baltimore, Santa Rosa Valley, CA (US)

(21) Appl. No.: 18/195,676

(22) Filed: May 10, 2023

Related U.S. Application Data
(60) Provisional application No. 63/340,706, filed on May 11, 2022.

(51) Int. Cl. B62D 43/00

(52) U.S. Cl. CPC B62D 43/002

(57) ABSTRACT

A spare tire mount that defines an internal storage space. The internal storage space provides mounting locations for a compressor and air tank assembly.

### CROSS REFERENCE TO RELATED APPLICATIONS

The preset application claims the benefit of U.S. Provisional Patent Application No. 63/340,706 filed May 11, 2022, and expressly incorporated by reference herein.

### FIELD OF THE INVENTION

The present disclosure relates to spare tire mounts and more particularly to a spare tire mount with an air tank and compressor.

### DESCRIPTION OF RELATED ART

Many vehicles, particularly four wheel drive vehicles, have spare tires mounted on a tailgate of the vehicle or under the vehicle. Additionally, many off road vehicles have aftermarket air tanks and compressors added. Some of these aftermarket devices are placed in the engine compartment, which take up valuable space and makes engine access difficult. Other devices are mounted in a truck bed or in storage spaces of the vehicle behind the seats, which reduces usable storage space and vehicle usability because bed space is minimized.

### SUMMARY OF THE INVENTION

What is needed is a aftermarket device for mounting an air tank and air compressor that does not have the drawbacks of the prior art.

According to one aspect of the invention, a spare tire mount is provided that defines an internal storage space. The internal storage space provides mounting locations for a compressor and air tank assembly.

The spare tire mount can be configured for a tailgate mount or an under vehicle mount.

In some aspects, the techniques described herein relate to a tire mount with an integrated air system, including: a housing configured to be mounted to a body component of a vehicle; an air compressor mounted to the housing; an air tank mounted in a space defined by the housing; and at least two studs arranged on an end face of the housing and configured as a mount for a tire.

In some aspects, the techniques described herein relate to a tire mount, further including a compressor mount configured to affix the air compressor to the housing.

In some aspects, the techniques described herein relate to a tire mount, wherein the housing includes a mounting plate having a mounting flange that mates with the body component of the vehicle.

In some aspects, the techniques described herein relate to a tire mount, further including one or more of a retractable air hose, a hose connector, a power receptacle, and a switch.

In some aspects, the techniques described herein relate to a tire mount, further including a housing portion configured to at least partially encase the air compressor.

In some aspects, the techniques described herein relate to a tire mount with an integrated air system, including: a first mount configured to be arranged on a first side of a rim of a spare tire; a second mount configured to be arranged on a second side of the rim of the spare tire that is opposite the first side of the rim of the spare tire, the second side vertically above the first side; wherein the second mount is configured to be arranged within a space defined by the rim of the spare tire; an air compressor mounted to the second mount; and an air tank mounted to the second mount; a lifting assembly configured to raise and lower the tire mount to access the spare tire; wherein the second mount has a recess configured allow the lifting assembly to contact the first mount.

### DESCRIPTION OF FIGURES

The invention will be described in more detail on the basis of an exemplary embodiment. In the figures:

FIG. 1 is a front perspective view of a tire mount with an integrated air system;

FIG. 2 is a rear perspective view of a tire mount with an integrated air system;

FIG. 3 is a bottom perspective view of a tire mount with an integrated air system;

FIG. 4 is a side view of a tire mount with an integrated air system; and

FIG. 5 top view of a tire mount with an integrated air system.

### DETAILED DESCRIPTION OF FIGURES

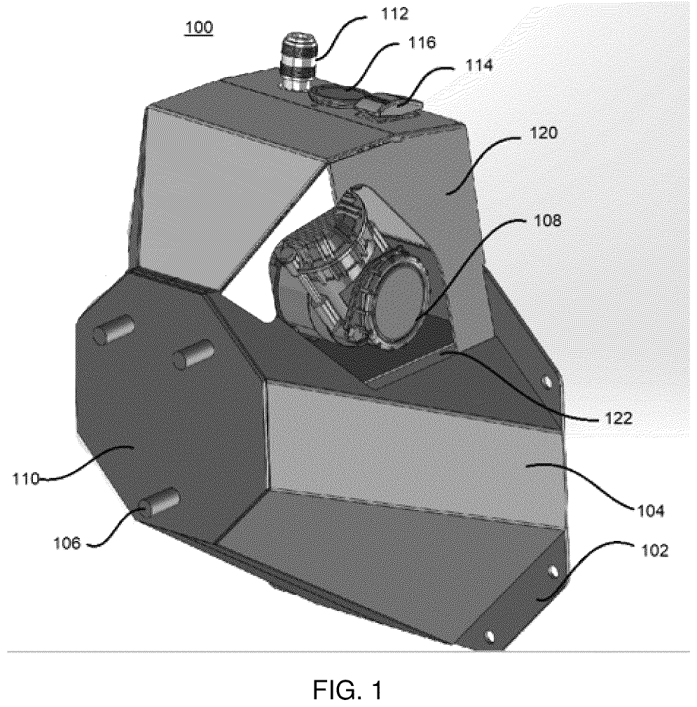

FIG. 1 is a front perspective view of an assembly 100 that is a tire mount with an integrated air system. The assembly 100 is configured to be affixed to a body panel of a vehicle, such as a tailgate. Alternatively, the assembly 100 can be mounted to a portion of a trailer or the like. The assembly 100 has a housing 104 that at least partially defines a mounting space for an air compressor 108 and preferably an air tank. The housing 104 has flanges 102 by which the assembly 100 is mounted to a tailgate of a vehicle. The assembly 100 can have different mounting patterns for different vehicles. A distal end 110 of the assembly 100 includes studs 106 configured to secure a spare tire. In one embodiment, a quick release air coupling 112 is provided. Other features can include a 12/24V socket 116, depending on the vehicle voltage, and a switch 114. According to one aspect of the invention, the air compressor 108 is protected by a housing portion 120 and the air tank is arranged inside the housing 104.

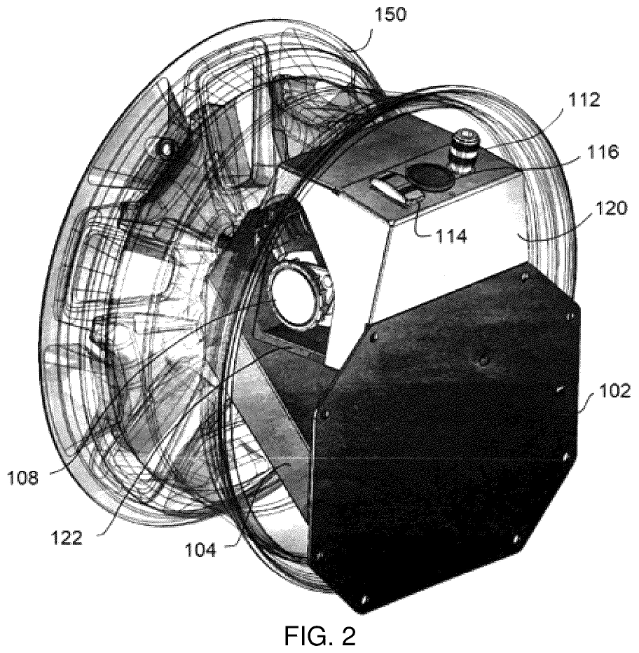

FIG. 2 is a rear perspective view of assembly 100. According to one aspect of the invention, the flanges 102 can be part of a back plate that is bonded to the housing 104. The back plate can be bonded to the housing 104 by welding, riveting, bolting, or the like. Alternatively, elements that make up the housing 104 can be bent to create the flanges 102. The back plate can have one or more openings for a wire harness to power the air compressor 108, a brake light, camera, or the like. The air compressor 108 is preferably not completely enclosed by the housing 104 and housing portion 120. The rim 150 for a spare tire is shown in FIG. 2. The air compressor 108 is at least partially arranged within the space defined by the rim 150. Preferably, the air compressor 108 is substantially entirely arranged within the space defined by the rim 150. The housing 104 includes a compressor mount 122. The compressor mount 122 preferably keeps the air compressor 108 in its proper mounting arrangement. For example, some air compressors must be mounted horizontally, some vertically, and for some orientation is irrelevant.

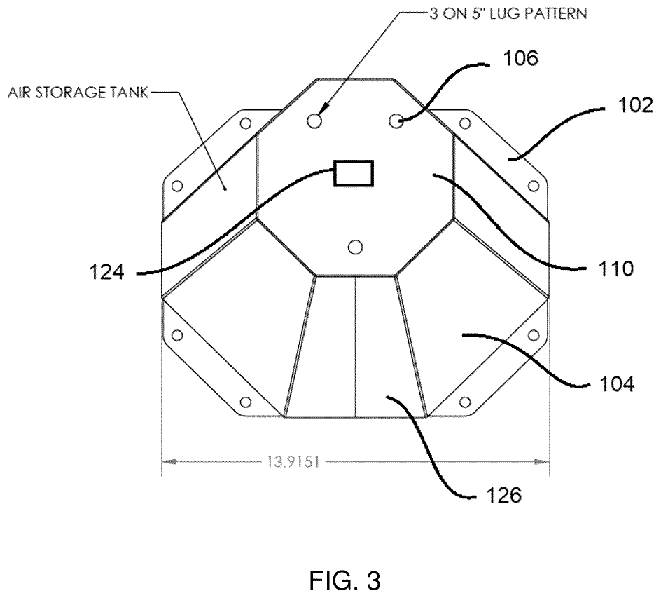

FIG. 3 is a bottom perspective view of the assembly 100. The housing 104 is made from a plurality of plates. The individual plates can be welded together. Alternatively, the housing 104 can be made from a single piece of metal that is folded into the configuration as shown. The housing 104 can comprise a plurality of panels leaving one or more open spaces by which the back plate 126 may be visible. It should be noted that the shape of the housing 104 and the mounting flanges can vary to accommodate different air tanks, air compressors, rims, and tailgate configurations. FIG. 3 shows three studs 106 for mounting a rim of spare tire. However, additional studs 106 can be present. Additionally, an optional backup camera 124 can be arranged on the distal end 110.

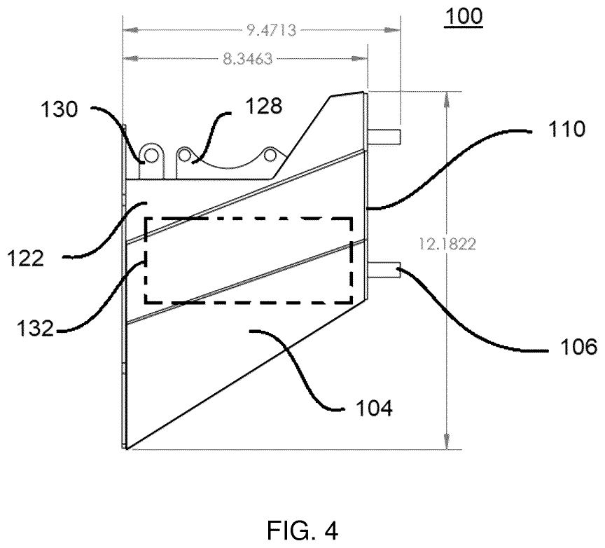

FIG. 4 is a side view of the assembly 100. As shown, the compressor mount 122 forms a horizontal mount for air compressor 108. Brackets 128, 130 are affixed to the compressor mount 122 to secure the air compressor 108. As would be understood to one skilled in the art, various mounting brackets can be provided for different air compressors. The brackets 128, 130 are attached to the compressor mount 122 by welding or other mechanical fastener like bolts, rivets, screws, or eth like. Alternatively, the compressor mount 122 is a stamped metal component and the brackets 128, 130 are formed during the stamping process. An air storage tank 132, shown in dashed line, is arranged within the housing 104.

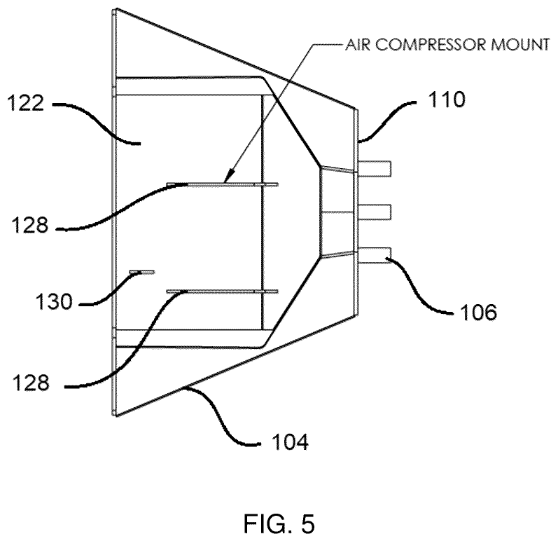

FIG. 5 top view of the assembly 100. The compressor mount 122 is arranged so that the compressor is at least partially surrounded by an area defined by a rim of a spare tire. The assembly 100 shown in FIGS. 3-5 do not include the housing portion 120. In one embodiment a retractable air hose is included in the housing 140.

For under vehicle spare tire mounts, the tire mount with an integrated air system would be arranged vertically above the rim a horizontal mount corresponding to compressor mount 122 would be arranged within the space defined by the rim. A central recess would be provided in the horizontal mount for the tire mounting apparatus. An air tank would also be arranged on the compressor mount 122. A retractable air hose can be attached or an air hose can be routed to an easily accessible location on the vehicle.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A tire mount with an integrated air system, comprising:
a housing configured to be mounted to a body component of a vehicle;
an air compressor mounted to the housing;
an air tank mounted in a space defined by the housing; and
at least two studs arranged on an end face of the housing and configured as a mount for a tire.

2. The tire mount according to claim 1, further comprising a compressor mount configured to affix the air compressor to the housing.

3. The tire mount according to claim 1, wherein the housing comprises a mounting plate having a mounting flange that mates with the body component of the vehicle.

4. The tire mount according to claim 1, further comprising one or more of a retractable air hose, a hose connector, a power receptacle, and a switch.

5. The tire mount according to claim 1, further comprising a housing portion configured to at least partially encase the air compressor.

6. A tire mount with an integrated air system, comprising:
a first mount configured to be arranged on a first side of a rim of a spare tire;
a second mount configured to be arranged on a second side of the rim of the spare tire that is opposite the first side of the rim of the spare tire, the second side vertically above the first side;
wherein the second mount is configured to be arranged within a space defined by the rim of the spare tire;
an air compressor mounted to the second mount; and
an air tank mounted to the second mount;
a lifting assembly configured to raise and lower the tire mount to access the spare tire;
wherein the second mount has a recess configured allow the lifting assembly to contact the first mount.
